(19) United States
(12) Patent Application Publication
(10) Pub. No.: US 2005/0027552 A1
(43) Pub. Date: Feb. 3, 2005

(54) Systems and methods for claim processing in a recovery audit

(76) Inventors: Joseph A. Massanelli, Dallas, GA (US); John Townsley Kidd, Atlanta, GA (US); Kevin L. Kitchens, Snellville, GA (US)

Correspondence Address: Malvern U. Griffin III;SUTHERLAND ASBILL & BRENNAN LLP, 999 Peachtree Street, NE, Atlanta, GA, 30309-3996, US

(21) Appl. No.: 10/822,483

(22) Filed: Apr. 12, 2004

Related U.S. Application Data
(60) Provisional application No. 60/462,151, filed on Apr. 11, 2003.

(51) Int. Cl. G06F 17/60; G06F 7/00; G06F 17/00

(52) U.S. Cl. 705/1; 705/30

(57) ABSTRACT

The systems, methods and computer program products of the present invention provide an expedited process for reviewing, validating and approving claims in a recovery audit. The claims are electronically packaged with supporting documents and securely distributed to clients. In an illustrative embodiment, a client receives an e-mail notice that one or more claims are ready for review, and via an Internet browser can review, approve and comments on one or more claims prepared by an auditor. Because the support documentation is immediately available, all parties have the same material as the basis of the claim before them to understand the source of the recovery. Once approved by the client (also referred to as the claimant), the same claim and supporting documentation can be provided to the vendor for review, and if appropriate, approval. Through this process, the present invention records communications among the parties to ensure a complete record.

### RELATED APPLICATIONS

The present application claims benefit of U.S. Patent Provisional Application Ser. No. 60/462,151, filed Apr. 11, 2003, which is incorporated herein in its entirety by reference.

### FIELD OF THE INVENTIONS

The present invention generally relates to recovery audits, and specifically to automated tools for web-based review, validate, approval and submission of claims identified by recovery audits.

### BACKGROUND OF THE INVENTIONS

Companies lose millions of dollars annually because of unpaid invoices, double payment, discounts and allowances not received and general overpayments. While some of these mistakes are rectified by annual audits performed by a company's accounting firm, such audits are generally not thorough enough to identify all the recoverable loses due to erroneous business transactions. As a consequence, companies hire firms to provide recovery audit services directed at identifying overpayments and collecting the monies due their clients for such erroneous payments.

The successful execution of a recovery audit is dependent on a number of factors, including the audit planning process and the collection of relevant documentation. The collection of relevant documentation is becoming more and more difficult. Where buy/sell transactions were once done almost exclusively on paper, today's business environment often results in these transactions being consummated via electronic documents. When these electronic documents are not part of a larger enterprise software solution (i.e., electronic invoicing systems), then accessing this information can be difficult. It is widely appreciated that companies are communicating with one another via e-mail in an ever-increasing fashion. Included in these e-mails are price commitments, notifications of price changes and vendor agreements with special discounts and allowances, all of which may be necessary documentation to have an effective audit.

The collection of relevant documentation is not only important in executing audits, but also in substantiating claims resulting from the audit. Typically, reviewing and approving claims can be a time consuming process for the client, the vendor, and the recovery-auditing firm. One significant reason for this time-consuming process is that the review of claims and documents supporting the claims is paper-intensive, and the multiple communications between the parties as they collaborate over a certain claim is difficult to manage and time consuming. The same claims and supporting documentation are typically reviewed individually and jointly in a meeting between the client and the recovery-auditor (also referred to herein as simply the auditor). Additionally, the validation process that occurs between the recovery-auditor and the client's vendor can also be paper intensive and may require several meetings or teleconferences to provide and review proper claim documentation.

The multiple communications between the parties can be by phone, e-mail, letter, in-person, etc., and therefore, may be difficult to track and assimilate, much less in a manner visible to all. In addition, monitoring the approval process is difficult given the decentralized manner in which it is currently done. Inefficiencies are difficult to identify, which may result in fewer claims being approved and/or an unnecessary delay from the time the claim is identified by the auditor to when the auditor can submit the approved claim to the client for payment.

Thus, an unsatisfied need exists in the industry for a more efficient means for a client to review and approve claims, and for a client to transmit the approved claim, along with the requisite documentation supporting the claim, to a vendor for review and authentication.

### SUMMARY OF THE INVENTION

The systems, methods and computer program products of the present invention provide an expedited process for reviewing, validating and approving claims in a recovery audit. The claims are electronically packaged with supporting documents and securely distributed to clients. In one embodiment, a client receives an e-mail notice that one or more claims are ready for review, and via an Internet browser can review, approve and comments on one or more claims prepared by an auditor. Because the support documentation is immediately available, all parties have the same material as the basis of the claim before them to understand the source of the recovery. Once approved by the client (also referred to as the claimant), the same claim and supporting documentation can be provided to the vendor for review, and if appropriate, approval. Through this process, the present invention records communications among the parties to ensure a complete record.

While the present invention has many advantage over the prior art, some of those advantages include better control of the claim review and approval process, real-time status, immediate validation through support documentation, better claim tracking for current and historical reports, reduced time for claim deduction, reduces audit expenses associated with copying, reduction in time required by a client to meet with auditors to review claims; simplification and organization of difficult to track recovery documentation; increase in speed of the vendor approval process; attachment of back-up documentation with the claim, such that a vendor need not wait for separately provided back-up information corresponding to a claim; providing a client with better control and up to the minute status of claims, and provides electronic tracking and documentation of recovery status; and improved vendor relations through an easier to use and cleaner claim process.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic block diagram illustrating a web-based claim processing system in accordance with an embodiment of the present invention.

FIG. 2 is a flow diagram of the operation of a web-based claim processing system in accordance with an embodiment of the present invention.

FIG. 3 is a flow diagram of the step of generating and delivering claims from FIG. 2 in accordance with an embodiment of the present invention.

FIG. 4 is a flow diagram of the step of claim review and approval by the client from FIG. 2 in accordance with an embodiment of the present invention.

FIG. 5 is a flow diagram of the step of claim review and approval by the vendor from FIG. 2 in accordance with an embodiment of the present invention.

FIG. 6 is a graphical user interface for providing a security log-in in accordance with an embodiment of the present invention.

FIG. 7 is a graphical user interface providing claims projects in accordance with an embodiment of the present invention.

FIGS. 8-9 are graphical user interfaces providing a claims manager for an auditor in accordance with an embodiment of the present invention.

FIG. 10 is a graphical user interface providing a search tool of the claims manager in accordance with an embodiment of the present invention.

FIGS. 11-12 are graphical user interfaces providing claim details in accordance with an embodiment of the present invention.

FIG. 13 is a graphical user interface for providing a response in accordance with an embodiment of the present invention.

FIG. 14 is a graphical user interface for approving a claim in accordance with an embodiment of the present invention.

FIG. 15 is a graphical user interface providing a document view in accordance with an embodiment of the present invention.

FIG. 16 is a graphical user interface for adding a comment and/or file in accordance with an embodiment of the present invention.

FIG. 17 is a graphical user interface for packaging a claim(s) in accordance with an embodiment of the present invention.

FIG. 18 is a graphical user interface providing a view of a notice e-mail to a user in accordance with an embodiment of the present invention.

FIG. 19 is an e-mail notification in accordance with an embodiment of the present invention.

FIG. 20 is a graphical user interface providing a claims manager for a client in accordance with an embodiment of the present invention.

FIG. 21 is a graphical user interface providing claim details in accordance with an embodiment of the present invention.

FIG. 22 is a graphical user interface for approving a claim in accordance with an embodiment of the present invention.

FIG. 23 is a graphical user interface for editing a stage in accordance with an embodiment of the present invention.

FIG. 24 is a graphical user interface providing a claims manager for a vendor in accordance with an embodiment of the present invention.

FIG. 25 is a graphical user interface for adding a comment and/or file to a claim in accordance with an embodiment of the present invention.

FIG. 26 is a graphical user interface providing claim details in accordance with an embodiment of the present invention.

FIG. 27 is a graphical user interface for approving a claim in accordance with an embodiment of the present invention.

### DETAILED DESCRIPTION OF THE INVENTIONS

The present inventions now will be described more fully hereinafter with reference to the accompanying drawings, in which some, but not all embodiments of the invention are described. Indeed, these inventions may be embodied in many different forms and should not be construed as limited to the embodiments set forth herein; rather, these embodiments are provided so that this disclosure will satisfy applicable legal requirements. Like numbers refer to like elements throughout.

It will be appreciated that the systems and methods of the present invention are described below with reference to block diagrams and flowchart illustrations. It should be understood that blocks of the block diagrams and flowchart illustrations, and combinations of blocks in the block diagrams and flowchart illustrations, respectively, may be implemented by computer program instructions. These computer program instructions may be loaded onto a general purpose computer, special purpose computer, or other programmable data processing apparatus to produce a mechanism, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

The present invention provides methods, systems and computer program products for web-based claim review, validation and approval, all of which can be performed in expedited manner. In the present invention, each claim is packaged electronically along with all relevant supporting documentation evidencing the basis for the claim. The claim and relevant back-up information are made accessible to the client via the Internet using a web browser. The client can access, review, validate and approve each claim at her or his convenience. Once reviewed and approved by the client, the claim along with its appropriate documentation is retrievable by a vendor for review, validation and approval. Because this process occurs via the Internet, the claim and its supporting information are easily accessible and available to all parties, which can view the same information and understand the source of the recovery.

With the present invention, the client can choose the time that is convenient to him or her. Because the claim and all of its documentation reside together, the client can see exactly how the claim was constructed, review its rationale and logic, and approve it at his or her convenience. Additionally, the client will have an organized record of all approvals and be able to see the status and vendor action on each approved claim.

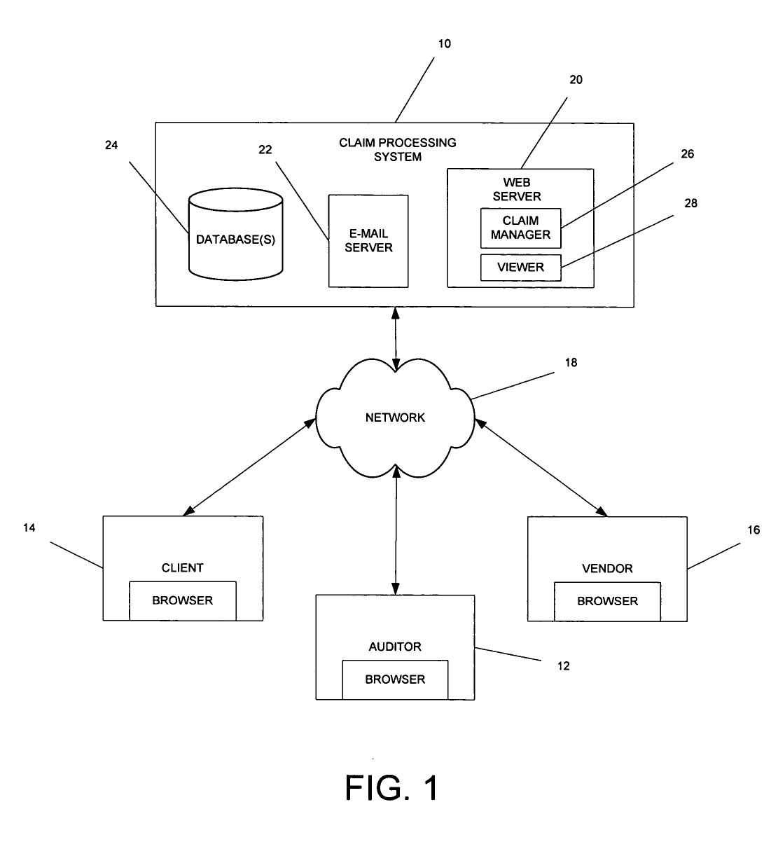

With reference to the figures, FIG. 1 is a block diagram illustrating an exemplary operating environment for implementation of certain embodiments of the present invention. The exemplary operating environment encompasses a claim processing system 10, an auditor device 12, a client device 14, and a vendor device 16, which are each configured for accessing and reading associated computer-readable media having stored thereon data and/or computer-executable instructions for implementing the various methods of the present invention. The auditor device 12, client device 14 and vendor device 16 are in electronic communication with the claim processing system 10 via a network 18, which may include one or more Local Area Networks (LANs) and/or one or more Wide Area Networks (WANs), and in the illustrated embodiment includes the Internet. Generally, network devices and systems include hardware and/or software for transmitting and receiving data and/or computer-executable instructions over a communications link and a memory for storing data and/or computer-executable instructions. Network devices and systems may also include a processor for processing data and executing computer-executable instructions, as well as other internal and peripheral components that are well known in the art. As used herein, the term “computer-readable medium” describes any form of memory or a propagated signal transmission medium. Propagated signals representing data and computer-executable instructions are transferred between network devices and systems.

The claim processing system 10 includes a web server 20, an e-mail server 22 and a database 24. The components of the claim processing system 10 may be collocated on a single computing device, such as a server or personal computer, or distribute over a LAN and/or WAN between multiple computing devices. Further, the components of the claim processing system 10 may be distributed themselves, such as database 24, which may comprise multiple databases operating under the control of a single or multiple database applications.

The web server 20 comprises a claim manager 26 and a document viewer 28. The claim manager 26 comprises the logic implementing the claim review, validation and approval functionality of the present invention, as described herein. The viewer 28 can be any viewer suitable for the secure viewing of document or images over a network. For example, the NetVue™ server commercially available from AccuSoft Corporation, Northborough, Me., may be suitable. BravaViewer from Informative Graphics Coporation, Scottsdale, Ariz. The viewer 28 enables the auditor 12, client device 14 and vendor device 16 to remotely view documents stored in database 24.

The database 24 comprises data and images. The data includes records of the claims identified by auditors and the images include supporting documentation associated with those claims. As an example, a claim record may include one or more of the following: claim date, claim amount, vendor name, vendor number, claim type, claim description, cancel amount, payback amount, client approval date, client approval amount, vendor approval date, vendor approval amount, age of claim, date last updated by client or vendor. The claim processing system 10 may include a document scanning and management system that enables one to scan and upload all pertinent documents used to support the claim. One such system is ImDex™, conceived and developed by the assignee of the present invention. Alternatively, the supporting documentation may be provided through remote access to such a system and/or transferred from such a system for local storage. The claims, once identified by the auditors, are stored as records on the database 24 for use by the claim manager 26. The claim processing system 10 also may include an audit system that is capable of identifying claims in an automated or manual fashion, or utilizing both automation and manual processes. Such systems often utilize filters to screen and cross-reference the electronic documents obtained from a system such as ImDex™ to identify recoverable claims against a vendor. Once identified, a record of the claim is generated, and the documents supporting the claim are associated therewith. For purposes of the review, validation and approval processes of the present invention, the claim records stored in database 24 can be generated by any suitable system or process.

The auditor device 12, client device 14 and vendor device 16 may be any suitable computing device with communication means suitable for interfacing with the network 18. The communication link between these devices and the network 18 may be wired, wireless, or a combination thereof. The devices themselves may be personal computer, thin client computers, PDAs, laptops, tablet computers, or any other suitable computing device. In the illustrative embodiment, the devices 12,14,16 include a web browser application such as Microsoft Explorer or Apple Safari to facilitate communication with the claim processing system 10, for example, over the Internet.

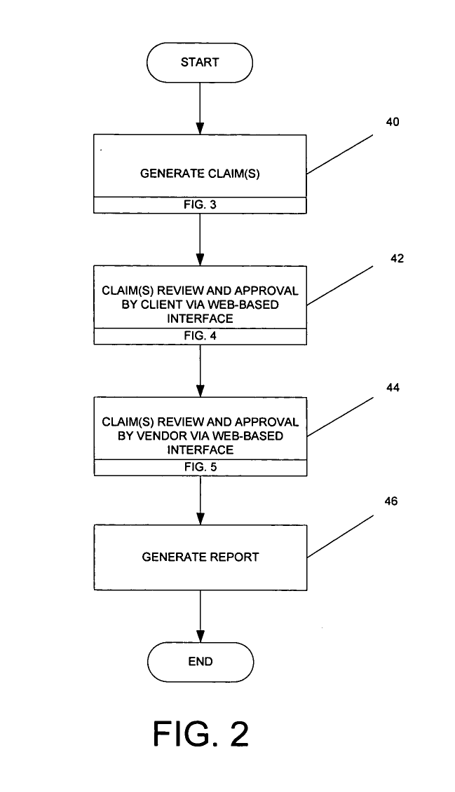

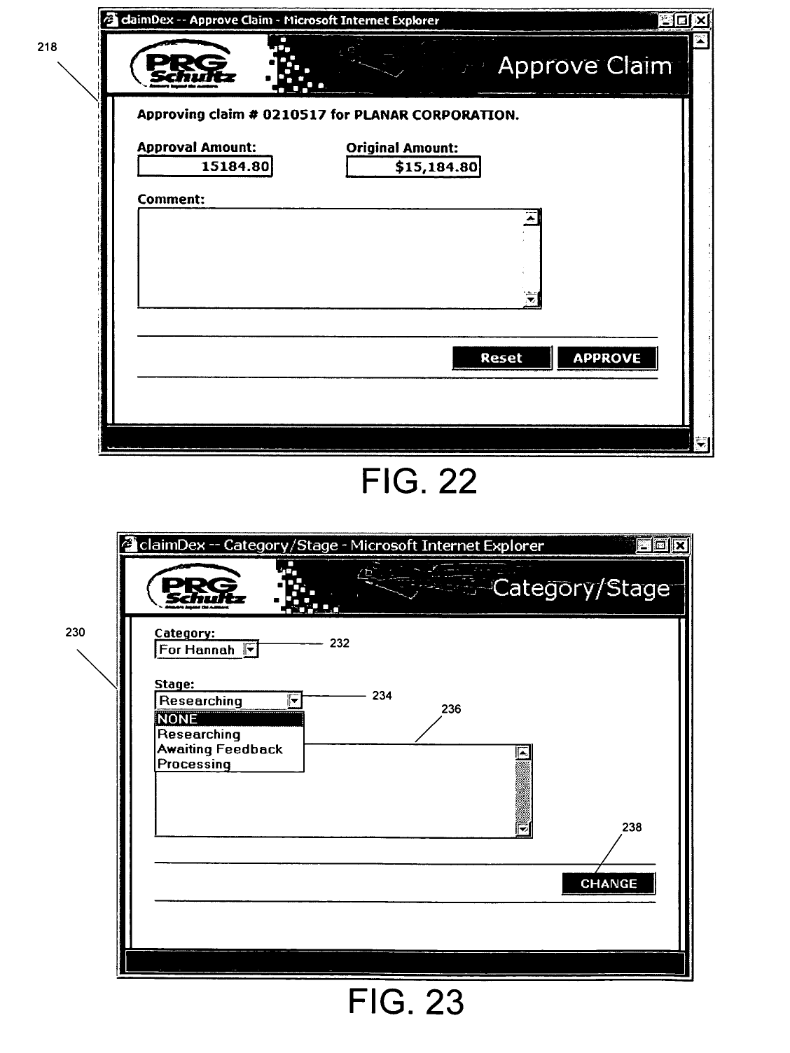

The operation and functionality of the claim processing system 10 will now be further described in the context of an illustrative embodiment provided in the flow diagrams and user interfaces of FIGS. 2-27.

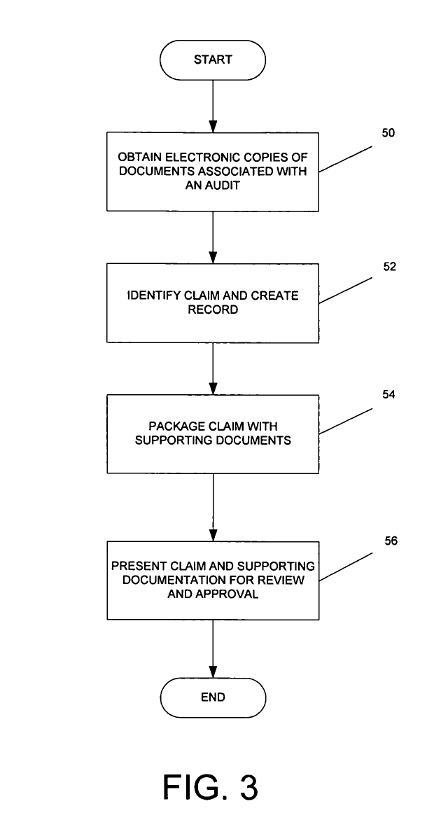

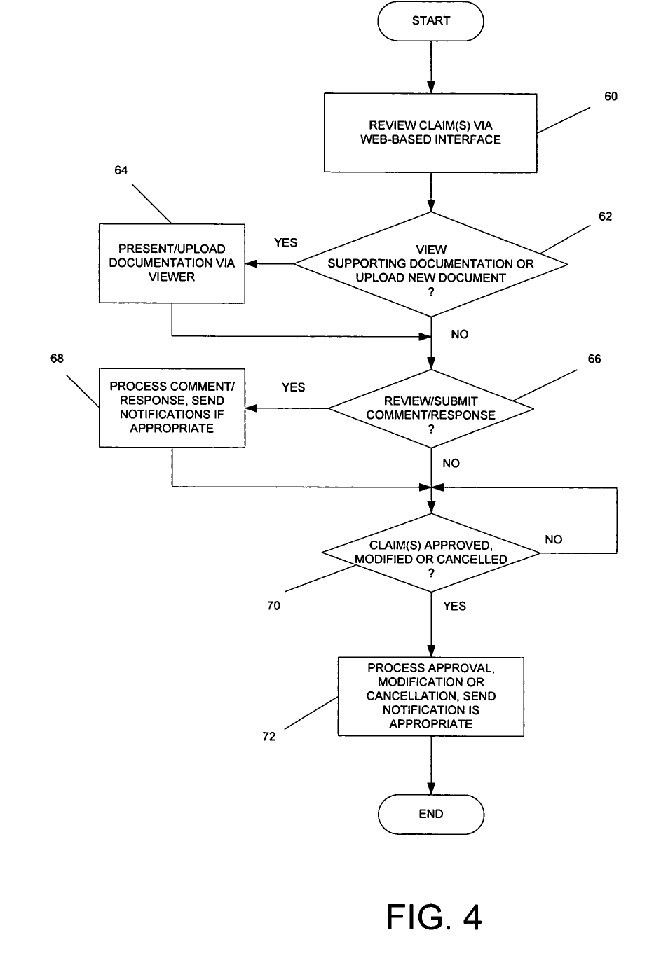

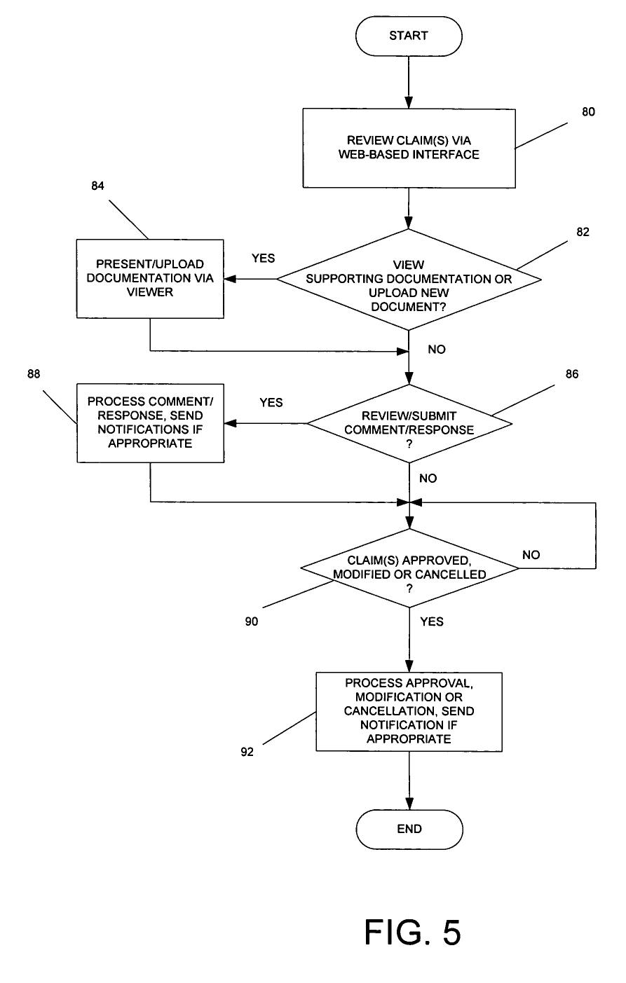

FIG. 2 shows a flow diagram illustrating a process implemented by the claim processing system of FIG. 1, according to one embodiment of the present invention. As shown in FIG. 2 the process begins at step 40 with the generation and presentation of one or more claims, as further disclosed with reference to FIG.3. Next, at step 42, the claim is reviewed and approved by the client via a web-based interface, as further disclosed in FIG. 4. At step 44 the claim is then reviewed and approved by the vendor via a web-based interface, as further disclosed in FIG. 5. Lastly, step 46 provides for the generation of reports based on data collected during the processing of one or more claims. It should be noted that the present invention is not limited to the particular process of FIG. 2, but may include additional processing steps, fewer processing steps, or a different ordering of the steps. Nonetheless, a claim processing system according to the present invention will include the review and approval of a claim and the supporting documentation via an web-based interface.

Because all communications and activity associated with a claim can be recorded by the present invention, reports pertaining to virtual any aspect of the process can be generated. For example, the auditor may want to generate reports pertaining to how long it takes to get a claim approved and which steps take the longest, whereas the client may want to generate reports pertaining to claims generated by vendor. If desired, reports can also be generated pertaining to vendor related issues, such as total claims approved.

FIG. 3 provides a flow diagram of an illustrative embodiment of step 40 in FIG. 2, which begins at step 50 with obtaining electronic copies of the support documents for an audit. The documents are then utilized to identify claims and to create a record of each claim, as indicated by step 52. In step 54, one or more of the claims then are packaged for delivery to the client. An e-mail notice is then delivered indicating that a one or more claims are ready for review and approval, as indicated by step 56. The e-mail notice may be sent to the client and/or vendor. In the illustrative embodiment, the e-mail notice is initially sent to the client, and once approved by the client, an e-mail notice is sent to the vendor. Each individual audit will have rules imposed by the client, auditor and maybe even the vendor as to the process flow for claim approval, as well known in the industry. For example, the client may pre-approved claim under a certain dollar amount, and therefore, such claims can be delivered to the vendor initially.

The e-mail notices include a link to a secure website where the recipient can gain access to the claim(s) and supporting documentation for their review and approval, as discussed below with reference to FIG. 4. By maintaining the claim and documentation at a central site for review, the system 10 is able to track various parameters associated with the processing of the claim, such as all activity on the web server 20 of the claim processing system 10, the time required to approve a claim, the number of times a claim is reviewed by the client or vendor before approval. In addition, control over access and communications between the parties can be achieved and records maintained.

FIG. 4 provides a flow diagram of an illustrative embodiment of step 42 in FIG. 2, which begins at step 60 with the client reviewing the claim, which in the illustrated embodiment is via a web-based interface such as a web browser. The review is initiated in the illustrated embodiment by the client selecting a link imbedded in the e-mail notice sent to the client's e-mail account. The link is a web address on the secure web server 20 of the claim processing system 10. The client logs into the password protected server to gain access to their claims. Detailed information about each claim is stored in database 24 and is presented to the client, as described in further detail below with reference to the illustrative user interfaces. At step 62, the client has the option of viewing the documentation supporting the claim or uploading additional documentation related to the claim. If the client chooses to view documentation, the documentation is retrieved from the database 24 and presented to the client by the viewer 28, as indicated by step 64. Alternatively, if the client is uploading documentation, that document is received and stored in database 24 and the associated claim record is updated. Next, as step 66, the client has the option of reviewing and/or submitting a comment and/or response to the claim(s). If the client chooses to review/submit a comment/response, such activity is processed and appropriate notifications are sent, as indicated by step 68. Lastly, at step 70, the client has the option of approving, modifying or canceling the claim. This action, if chosen, is processed at step 72. It should be noted that the options of step 62, 66 and 70 are sequentially independent of one another in that the client can act upon these options in the order desired, and is not limited to any particular sequence. The illustrated flow diagram included a sequential relationship for purposes of simplifying the illustration. As will be appreciated upon review of the illustrative user interfaces, these options are independently selectable by the user.

FIG. 5 provides a flow diagram of an illustrative embodiment of step 44 in FIG. 2, which begins at step 80 with the vendor reviewing the claim, which in the illustrated embodiment is via a web-based interface such as a browser application operated by the client. The claim at this point may have been approved by the client, though it is possible that certain claims will not require client approval prior to delivery to the vendor. The review is initiated in the illustrated embodiment by the client selecting a link imbedded in the e-mail notice sent to the client's e-mail account. The link is a web address on the secure web server 20 of the claim processing system 10. The client logs into the password protected server to gain access to their claims. Detailed information about each claim is stored in database 24 and is presented to the client, as described in further detail below with reference to the illustrative user interfaces. At step 82, the vendor has the option of viewing the documentation supporting the claim or uploading additional documentation related to the claim, such as a pricing or order for the subject transaction. If the vendor chooses to view the documentation, the documentation is retrieved from the database 24 and presented to the vendor by the viewer 28, as indicated by step 84. Alternatively, if the vendor is uploading documentation, that document is received and stored in database 24 and the associated claim record is updated. Next, as step 86, the vendor has the option of reviewing and/or submitting a comment and/or response to the claim(s). If the vendor chooses to review/submit a comment/response, such activity is processed and appropriate notifications are sent, as indicated by step 88. Lastly, at step 90, the vendor has the option of approving, modifying or canceling the claim. This action, if chosen, is processed at step 92. It should be noted that the options of step 82, 86 and 90 are sequentially independent of one another in that the vendor can act upon these option in the order desired, and is not limited to any particular sequence. The illustrated flow diagram included a sequential relationship for purposes of simplifying the illustration. As will be appreciated upon review of the illustrative user interfaces, these options are independently selectable by the user.

According to one aspect of the present invention, the claim manager 26 may comprise a software product for generating graphical user interface via web server 20 for user interaction with the claim processing system 10. Therefore, it will be understood that each of the accompanying graphical user interfaces can be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functions illustrated by and described with reference to the illustrative user interfaces provided below.

These computer program instructions may also be stored in a computer-readable memory that can direct a computer or other programmable data processing apparatus to function in a particular manner, such that the instructions stored in the computer-readable memory produce an article of manufacture including instruction means that implement the function illustrated by the interfaces. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified herein.

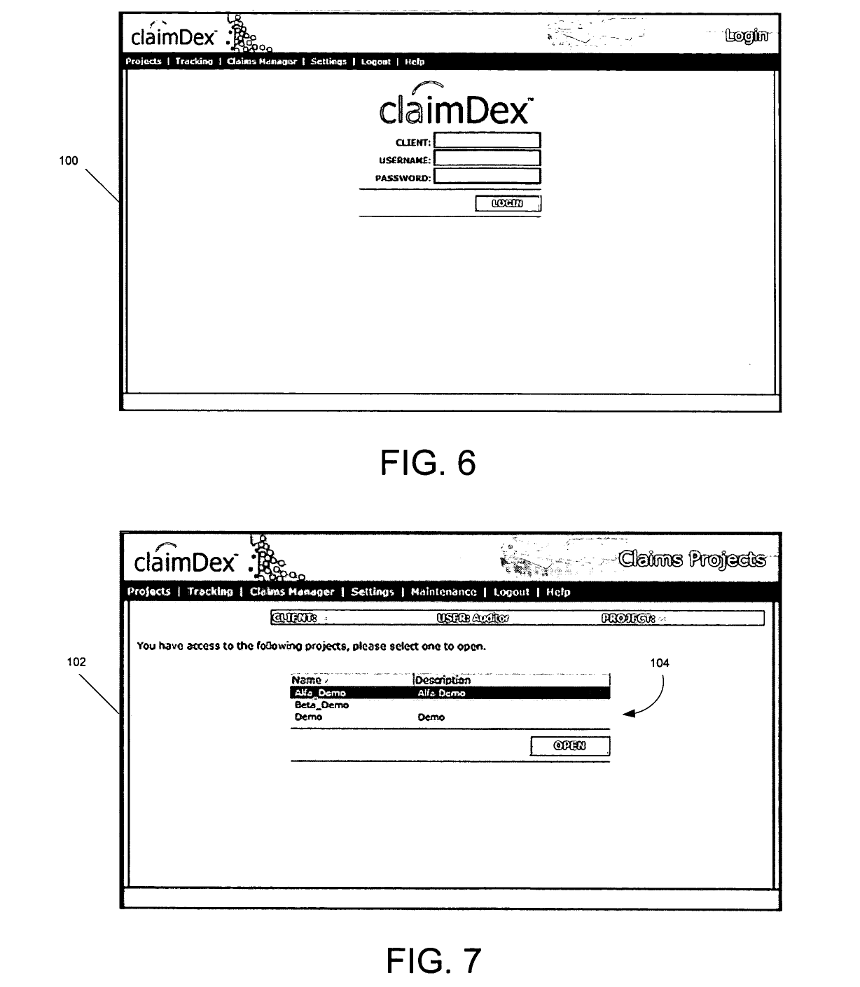

FIGS. 6-27 illustrate some of the graphical user interfaces provided by the web-based review and approval of the present invention to access, review, comment on, respond to, edit and approve claims, and to identify, view and upload their respective back-up information, according to one embodiment of the present invention. It will be appreciated that the graphical user interfaces are used by clients, auditors and vendors/buyers for reviewing, editing and approving claims and their associated supporting documentation. The interfaces are web-based such that the clients, auditors and vendors/buyers can access the interfaces via the Internet, at any time, and from any location. The clients, auditors and vendors/buyers are described herein generally as users. It will also be appreciated with reference to the interfaces that some of the functions described herein are only available to some of the users accessing the interfaces. As an example, vendors/buyers may not confidential client information or information relating to claims not associated with the vendor.

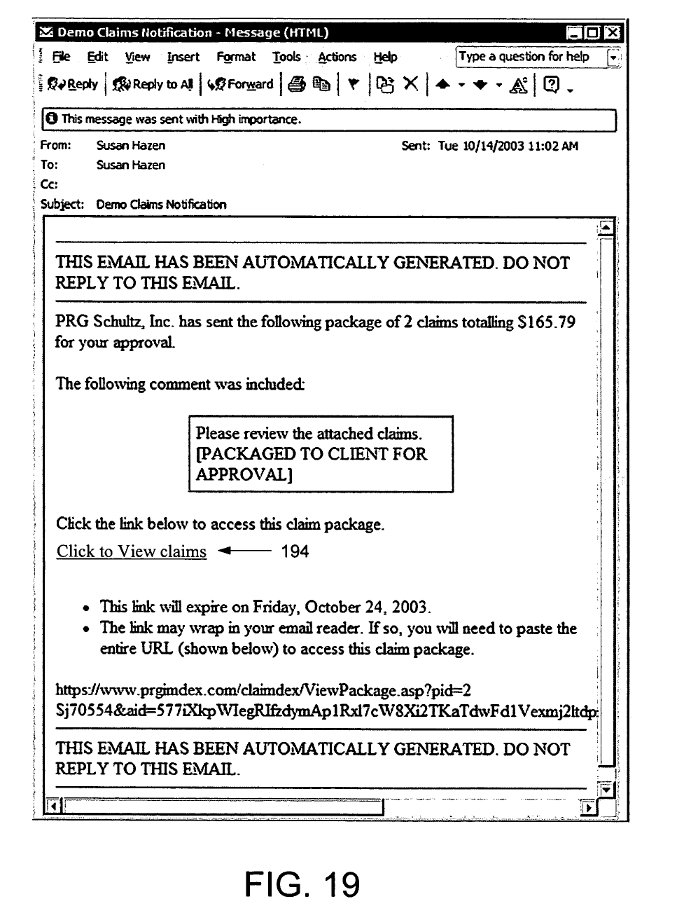

FIGS. 6-18 provide the graphical user interfaces presented to the auditor, though many of which also will be presented in the same or substantially the same form to the client and/or vendor. FIGS. 19-23 provide user interface presented to clients and FIGS. 23-27 provide user interfaces presented to the vendor.

According to one aspect of the invention, the various access rights are established by the username and password provided by a person logging onto the web-based system. This information, as is known in the art, may also be embodied in cookies provided by the web server serving the pages or in other communications, such as e-mail links, which may be used to access particular information via the interfaces, as described below. Finally, it will be appreciated that the web pages described herein may be created and served to users via the web server 20 under the control of the claim manager 26.

FIGS. 6 and 7 provide two initial user interfaces presented to the auditor, client and vendor. FIG. 6 provides a security log-in interface 100 that governs access to functions such as viewing, annotating, and administering information through the user interfaces discussed herein. Therefore, usernames and passwords may be configured to have varying levels of security such that only some of the functions described herein are available to each logged-in user. Additionally, the log-in screen requests a client identifier corresponding to the client whose claims and supporting documentation are to be accessed, edited and/or verified.

As shown in FIG. 7, upon accessing the system, the claim manager 26 provides a user the names of the projects 104 to which that user has access via user interface 102. In the illustrated embodiment, the projects are audits to which the user has rights, though the projects could represent aspects of a single audit or multiple audits for multiple clients. Therefore, the system of the present invention enables access and organization of multiple auditing reviews for each client. As an example, separate projects may be created for each year. The creation of new projects is also facilitated by this interface if the user has access to such a function. As shown in the illustrative example of FIG. 7, the user has three projects available to view: Alfa Demo, Beta Demo and Demo.

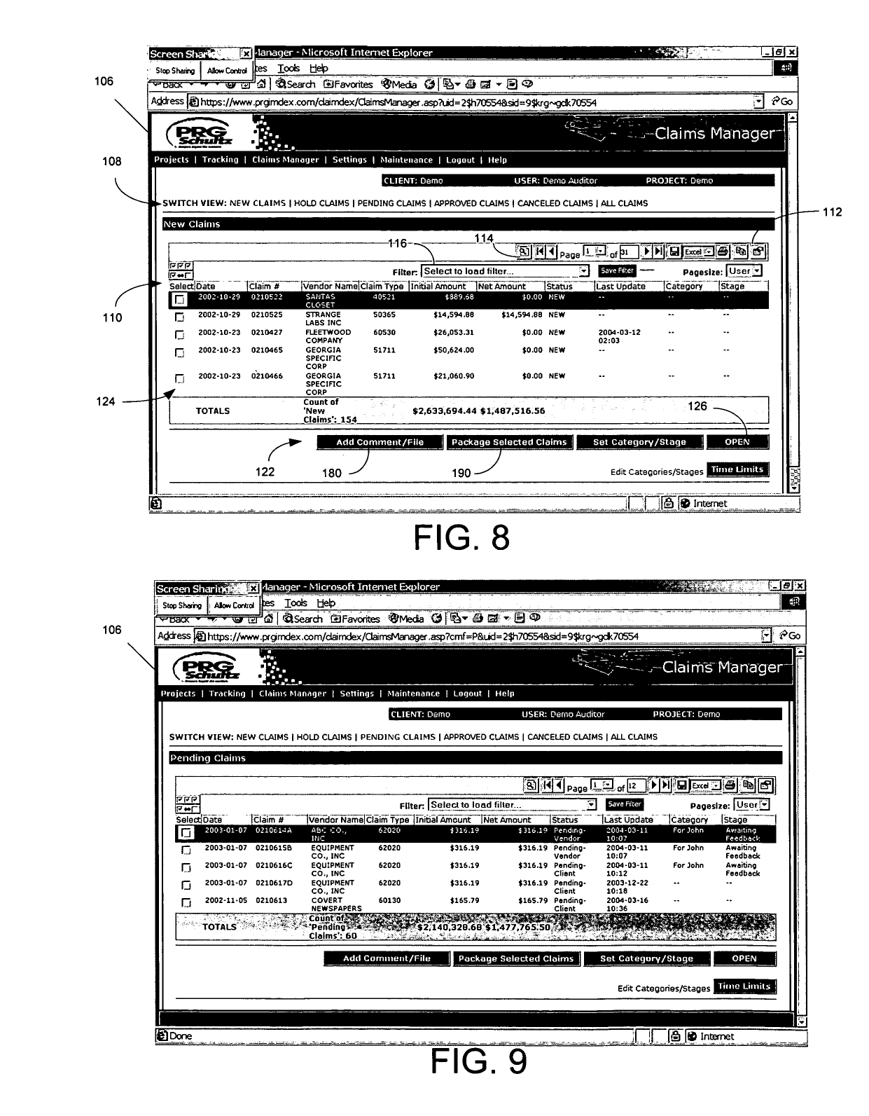

Upon selecting a project to view and open, the user is presented with the claims manager interface 106 showing detailed claim information, as shown in FIG. 8. This particular interface is the auditor claims manager interface. The user can select a number of varying claim information views 108, including new claims, pending claims, approved claims, and all claims. Each view shows the claims corresponding to the title of the view (i.e., new, pending, approved, or all claims). In the illustrative interface of FIG. 8, the auditor is presented with new claims, whereas the illustrative interface of FIG. 9 the auditor is presented with pending claims, that is, claims that have not been sent to the client and/or vendor.

As shown in FIG. 8, the interface provides basic information corresponding to each claim, including the date of the claim's creation, the claim number, the vendor's name, the claim type, the initial and net amounts of the claim, the status of the claim, the date of the last update to the claim and the category and stage. The columns of information 110 may be customized to show different information using button 112, which will provide a list of selectable columns that can be displayed, including but not limited to the age of the claim in days, the vendor number, a text description of the claim type. Additional buttons are also available in a toolbar above the claim information to provide additional functionality, including viewing, printing and saving, as are well known in the art. Of particular interest, the save function allows the user to save and capture the displayed claim data into different formats, such as directly into an Excel spreadsheet or Word document, HTML or XML.

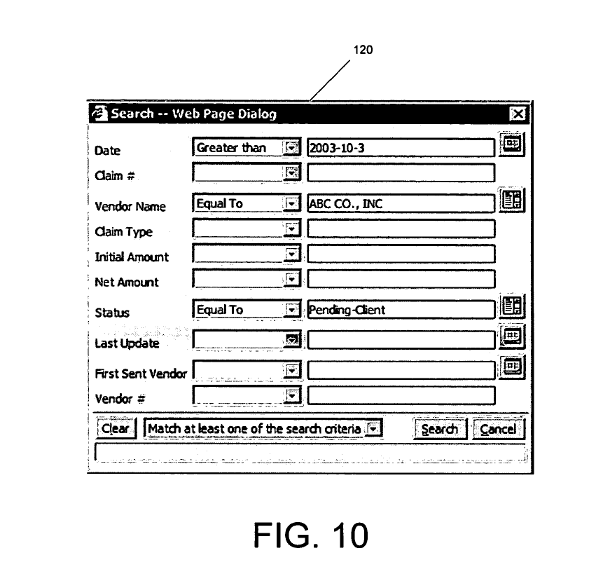

The claims may be searched and filtered by the auditor by selecting the search button 114 or selecting a pre-saved search (i.e., filter) via pull-down menu 116. When the auditor selects the search button 114, search interface 120 of FIG. 10 is presented to the auditor for defining the search query. Once the auditor has specified the records that he or she wishes to view, the filter and other grid settings can be saved by clicking a save filter button 122 of the claims manager interface 106 and specifying a name for the filter.

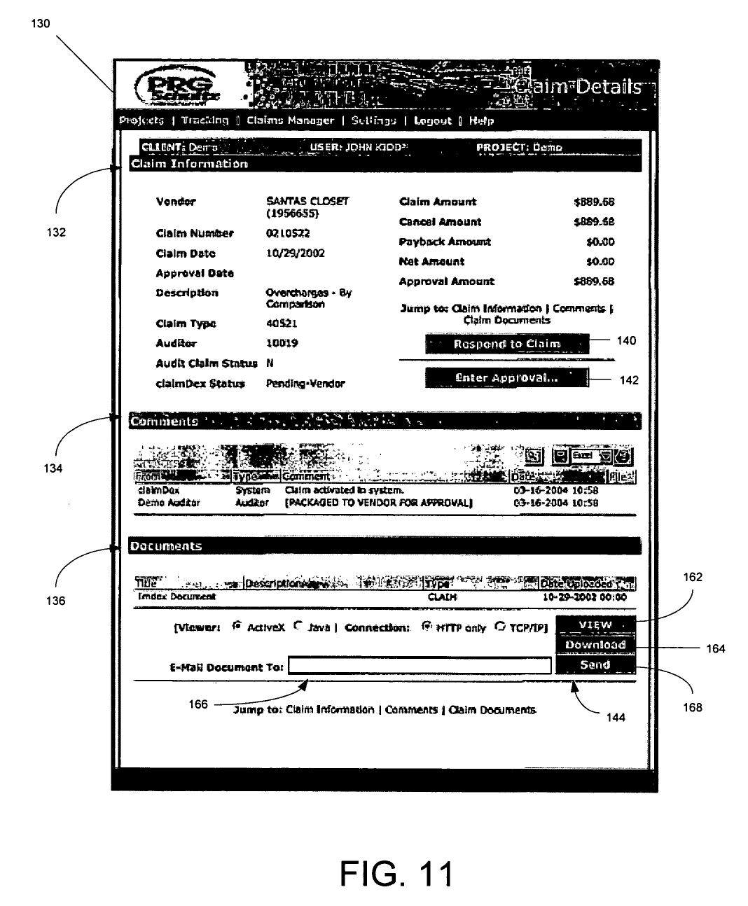

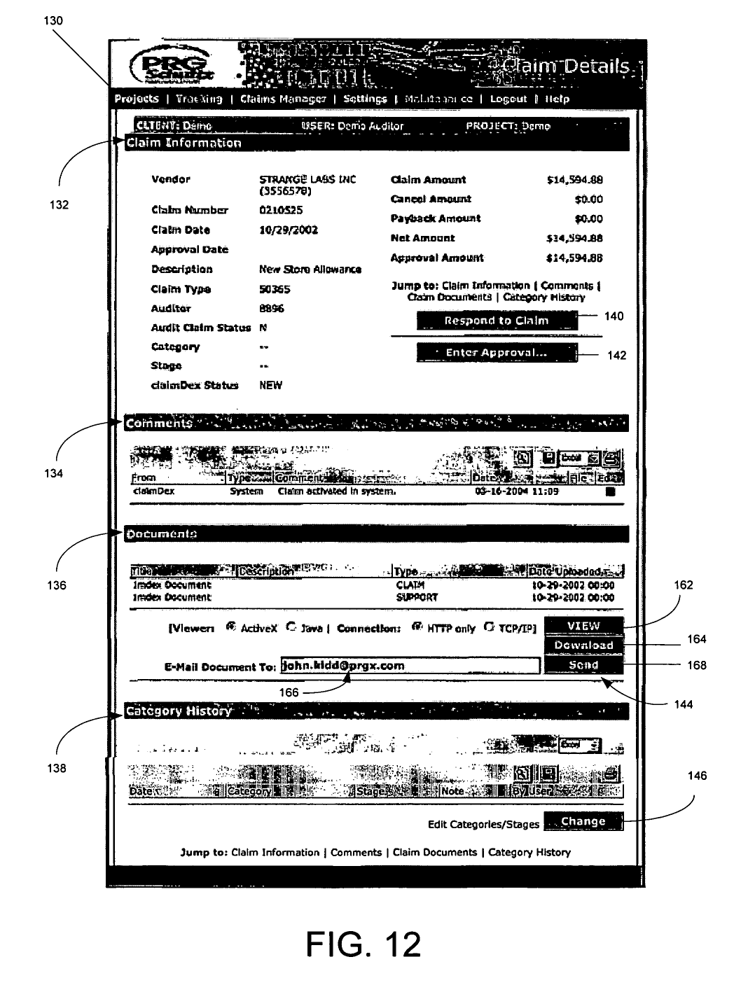

The claims manager interface 106 presents the auditor with four activity buttons 122 for use in processing the claims. The auditor can select, via the selection buttons 124, one or more claims to review in greater detail. After selecting a claim and selecting the open button 126, detailed claim information is provided via the claim details interface 130, as shown in FIGS. 11 and 12. The claims detail interfaces of FIGS. 11 and 12 include a Claim Information section 132, a Comments section 134 and a Documents section 136. The claim details interface 130 of FIG. 9 also includes a Category History section 138.

The Claim Information section provides the basic claim information shown in the claims manager interface 106 and additional information such as the approval date, the auditor, a description, an audit claim status, and detailed amount information, such as the payback amount, net amount and approval amount. The auditor has the options of submitting a response to the claim via button 140 and approving the claim via button 142. The Comments section 134 enables the auditor to view, edit and search the comments submitted on the present claim. The Document section 136 enables the auditor to view, download or send (i.e., upload) claim documents associated with the claim via individually selectable buttons 144. Lastly, the Category History section enables the auditor to change the categories and/or stage via selectable button 146, as discussed below.

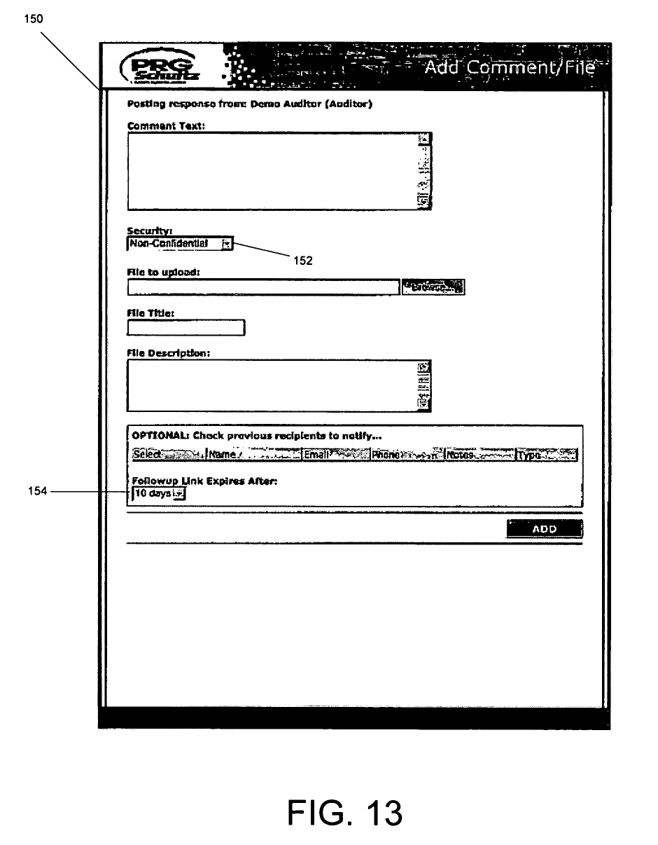

If the auditor selects the Respond to Claim button 140 at the claim detail interface 130, the user is taken to the add comment/file interface 150 shown in FIG. 13, which allows the user to respond to the claim, to add documents that the user wishes to associate with the claim and to send e-mail notifications to other parties alerting them of the response. The response may be intended for a limited audience, in which case the auditor can select an appropriate security level from the drop-down menu 152. For example, the auditor may select non-confidential (anyone with access to the claim can view it), audit only (only auditors can view) or audit/client only (only auditors and the client can view it). Also, if previous recipients are identified for e-mail notification of the response, the auditor can set an “expires after” timeframe 154 to limit how many days the recipient will have to access the response through e-mail notification.

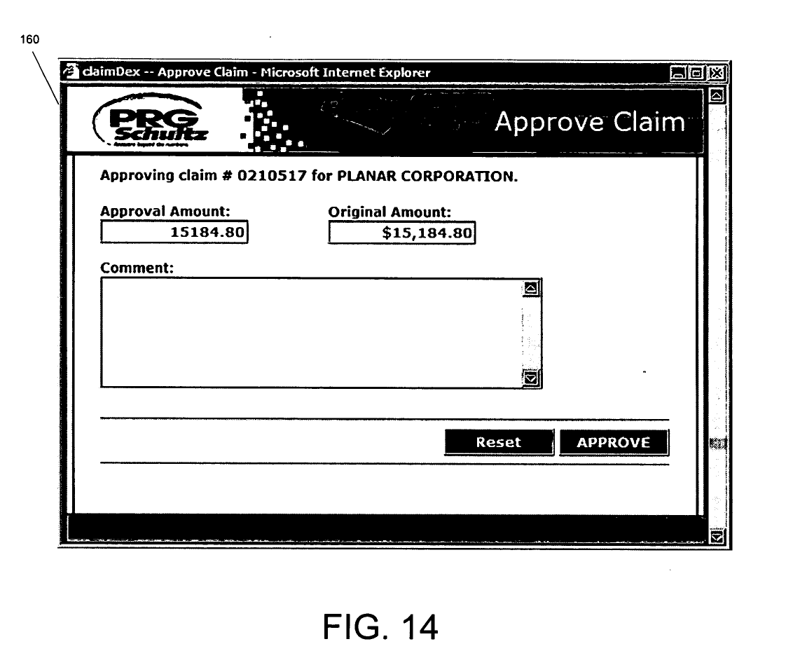

From the claim detail interface 130, the auditor may also approve a claim by selecting the Enter Approval button 142, which takes the auditor to the approve claim interface 160 shown in FIG. 14. At this interface, the auditor can approve the original claim amount or insert and approve a different claim amount, and submit a comment. Once approved, then the claim can be packages and sent to the client and/or vendor from the claims manager interface 106, as discussed below.

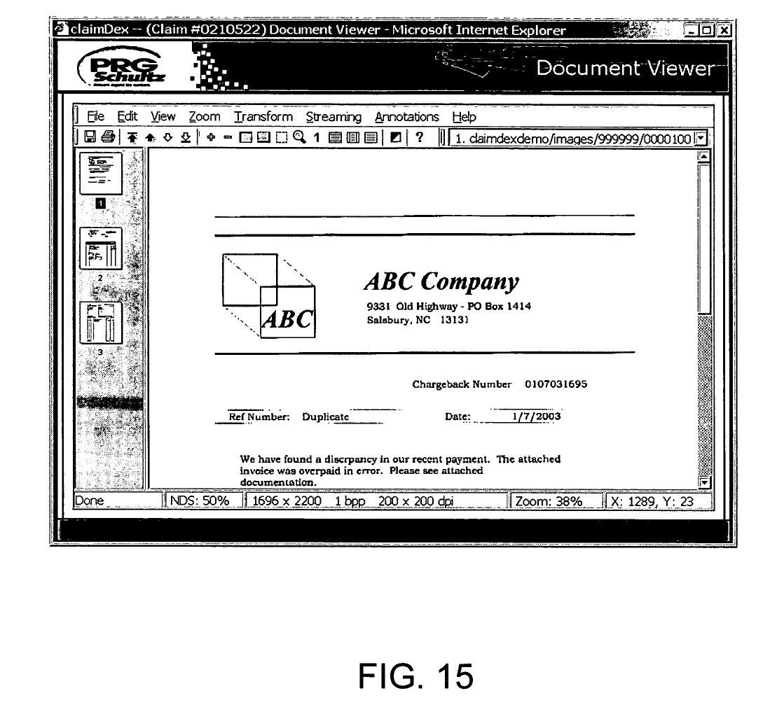

From the claim detail interface 130, the auditor may also view, download and send a document from the Documents section 136. By selecting the View button 162, the document will be presented to the auditor in the format requested by the viewer 28 of web server 20. An illustrative presentation of a document is provided in FIG. 15. In addition, the auditor can download a copy of the document by selecting the Download button 164 or e-mail the document to someone by inserting an e-mail address into window 166 and selecting the Send button 168.

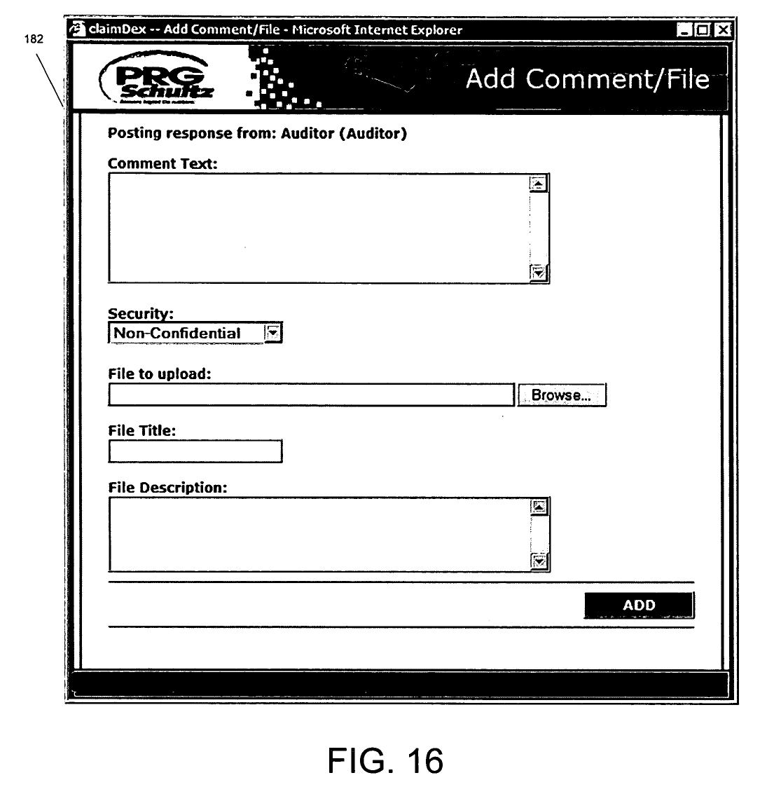

Referring back to the claims manager interface 106, the auditor may submit a comment or add a document by selecting one or more claims via selection boxes 124 and selecting the Add Comment/File button 180. This takes the auditor to a add comment/file interface 182, as shown in FIG. 16, which is substantially similar to the response interface 150. Comments are different from responses in that there is no option to send e-mail notifications when adding a comment and comments can be added to multiple claims at one time whereas a response can only be added to one claim at a time. Otherwise, the operation of the interfaces 150 and 182 are substantially similar in that the add comment/file interface 182 allows the auditor to add a comment, apply a desired level of security to the comment and upload a document.

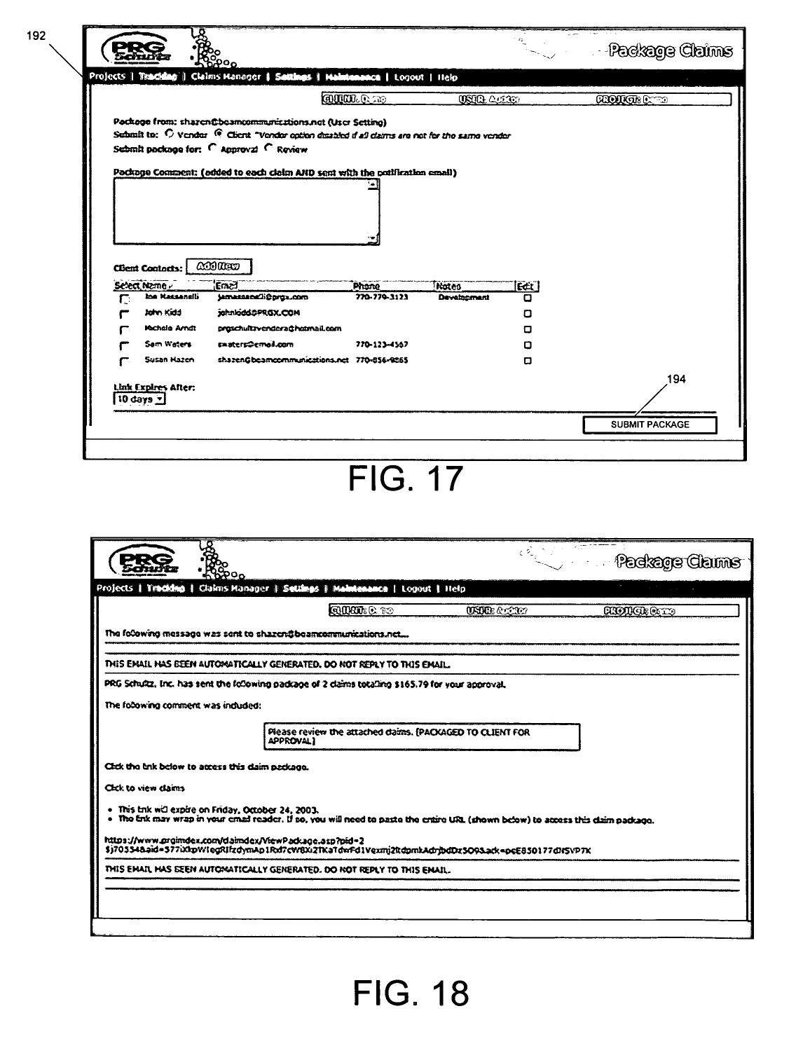

When one or more claims have been approved and are ready to be packaged and sent to the client and/or vendor, the auditor may select the Package Selected Claims button 190 of the claims manager 106. This takes the auditor to a package claims interface 192, as shown in FIG. 17. At this interface, the auditor can designate who the claim(s) will be submitted to, designate purpose of submission as review or approval, add a comment, and select the specific clients/vendors to which the package is to be sent. Additional contacts can be added if desired, and the link can be set to expire after a predefined number of days to limit how long the recipients will have to access the claim package. Once the Submit Package button 194 is selected, the contents of the notice e-mail sent to the client/vendor is displayed to the auditor, as illustrated in FIG. 18. An illustrative example of an e-mail sent to the designated client contacts informing them that a claim package has been prepared for their review/approval is shown in FIG. 19.

The above-described graphical user interfaces therefore allow an auditor simple and immediate access to claim information, including status, and support documents evidencing the basis for the claims. Because the interfaces are web-enabled, an auditor only needs a web-browser and an Internet connection to access the interfaces. The following user interfaces are those generated for the client and vendor when accessing the claim for review, validation and approval. Many of the interfaces common to the auditor, client and vendor are not reproduced but discussed in reference to the corresponding auditor interface described above.

In the processing of claims, as discussed above, each client will have their particular rules regarding approval. For example, a client may not require its approval over claims below a certain dollar value. Alternatively, the auditor may require sole approval rights over certain claim types. There also may be vendor requirements that must be considered in the processing of claims, such as the length of time that a claim is considered valid. Regardless of the processing limitations, the claim manager of the present invention is highly configurable so as to enable most any claim processing scheme. In most case, claims will be initial sent to the client for approval prior to being sent to the vendor. Accordingly, the following discussion will discuss the claim processing at the client and the vendor, though the present invention is not limited to any particular processing order.

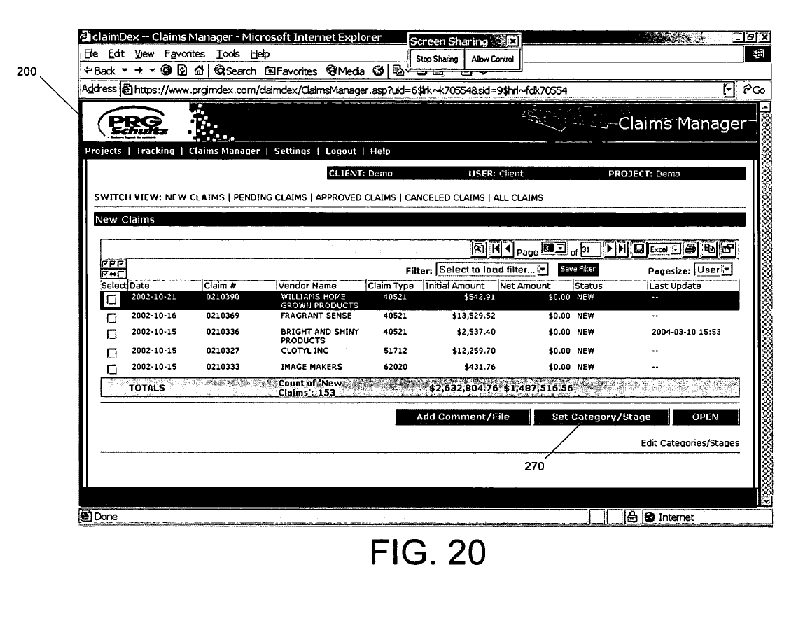

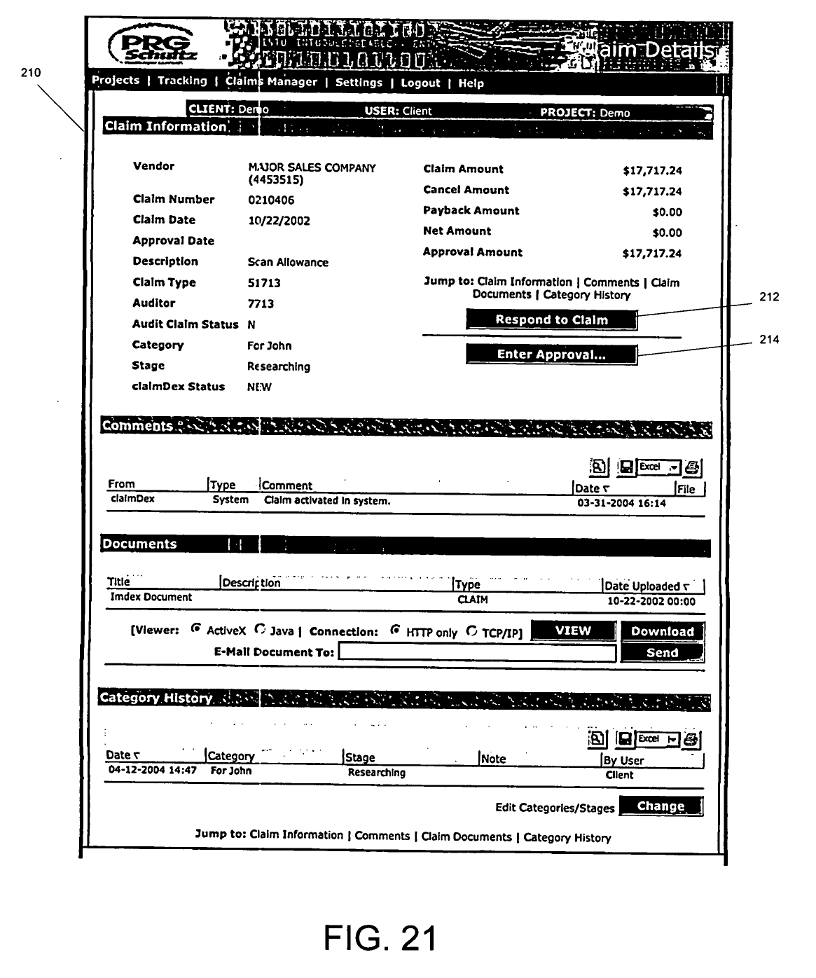

The client receives an e-mail notice, such as the one illustrated in FIG. 19, once the auditor submits a package identifying the client as a recipient. The e-mail describes the claim package by the number of claims and the total amount. The e-mail also provides a time-limited link 194 to allow the client to access the claim package, such as through a web browser. As with the auditor, the client is presented a log-in page and project list interface, similar to interfaces 100 and 102. Once the client successfully logs into the claims manager application, commercially referred to as ClaimDex™, the client is presented with a client claims manager interface 200, as illustrated in FIG. 20. The client claims manager interface 200 provides substantially the same functionality as the auditor claims manager interface 106 though it does not have the Package Selected Claims button 190. The client claims manager presents the client with multiple views and search capability just like the auditor claims manager. The claims viewable by the client, however, are only those claims packaged for the client by the auditors. The client may open a claim to review the claim details via a claim details interface 210, as illustrated in FIG. 21. Again, this is substantially similar to that presented to the auditor. The client may respond to the claim by selecting the Respond to Claim button 212, which will take the client to the add comment/file interface 214, and approve the claim by selecting the Enter Approval button 216, which takes the client to the approve claim interface 218. The add comment/file interface 214 and the approve claim interface 218 operate in substantially the same manner as the corresponding interfaces presented to the auditor, as discussed above.

The client also has the option from the claims manager interface 200 to set the category and stages for defining the process flow of how a claim is process internally. While the auditor has the same option from their claims manager interface, this feature is described herein from the perspective of the client. By selecting the Set Category/Stages button 220 on the claims manager interface 200, the client is taken to the category/stage interface 230, as illustrated in FIG. 23. At this interface, in the illustrated embodiment, the client selects a category, which may be a person or group responsible for certain claims, utilizing the drop-down menu 232 and then updates the stage from a list of internal workflow stages which may be defined by the client (for example, Researching, Awaiting Feedback or In Process), utilizing drop-down menu 234. The client also may insert a comment in text field 236. Once completed, the client selects the Change button 238 and the record for that claim is updated within the claim processing system 10 so the Category History section of the Claim detail interface will reflect the change.

Once the claim has been approved by the client, or in cases where the client approval is not needed, the claim is sent to the vendor. The auditor may review the claim once it has been approved by the client to evaluate any comments or changes made by the client. The auditor then packages the claim for delivery to the vendor, which results in an e-mail to the vendor. This e-mail will be substantially the same as that illustrated in FIG. 19.

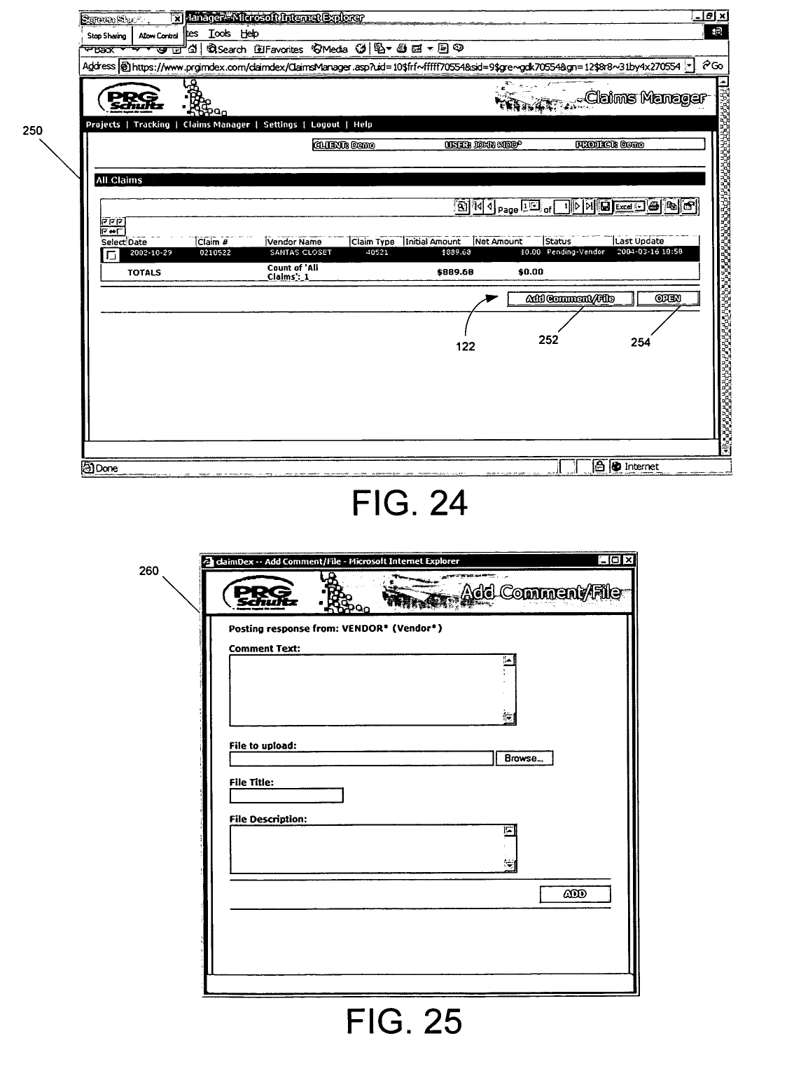

As with the auditor and client, the vendor must log into the claim processing system 10 via interfaces substantially similar to those illustrated in FIGS. 6 and 7. The vendor is then presented with a vendor claims manager interface 250, as illustrated in FIG. 24, which presents all the claims being asserted against the vendor and provides the search, export and print functionality provided y the auditor and client claims manager interfaces. The vendor, however, is not presented with the same activity buttons 122 as the auditor and vendor. The vendor is presented with two activity button 122, an Add Comment/File button 252 and Open button 254.

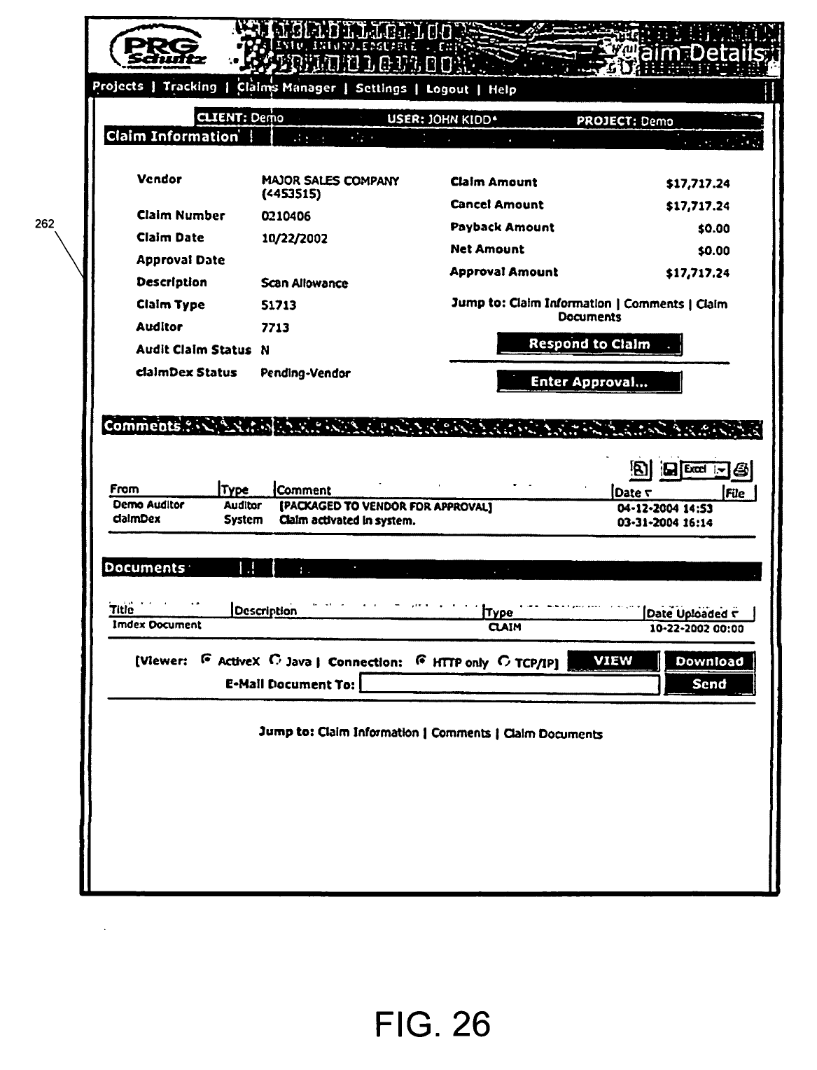

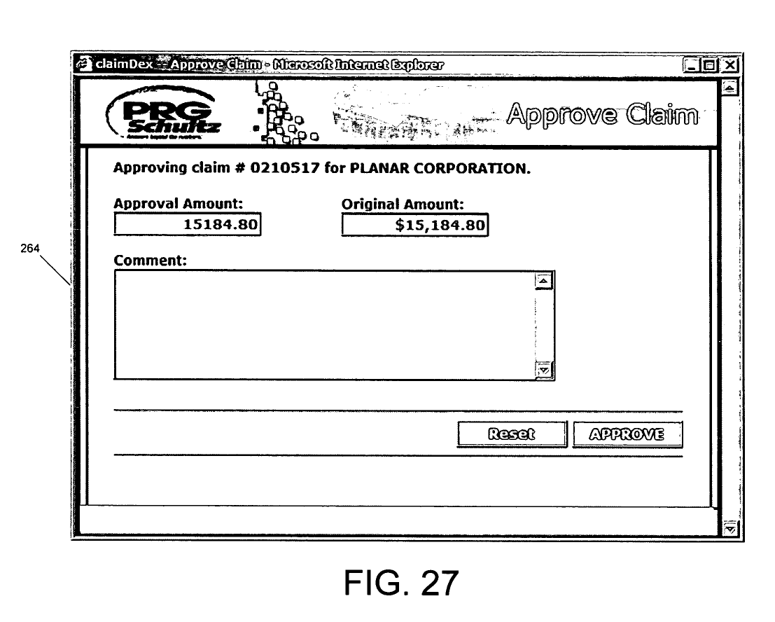

By selecting the Add Comment/File button 252, the vendor is taken to an add comment/file interface 260, as illustrated in FIG. 25, which operates substantially similar to the auditor add comment/file interfaces 182 discussed above. This includes the option to add a file that may rebut the claim, such as a price list, e-mail communication, etc. By selecting the Open button 254, the vendor is taken to a claim details interface 262, as illustrated in FIG. 26. From the claim detail interface 262, the vendor can respond to the claim, which operation is substantially similar to the auditor or client responding to a claim, as discussed above, and approve the claim. As with the auditor and client, an approve claim interface 264, as illustrated in FIG. 27, allows the vendor to modify the amount of the claim as well as submit a comment.

Once the vendor approves the claim, the claim record is immediately updated and the audit can review the claim and submit to the client for deduction. If the audit finds an issue with the approval (e.g., a partial approval that is questionable), the audit may have further conversations with the vendor through the claim interface until the claim is resolved. Without the present invention, this process could take much longer and in some cases due to the manual nature of the current process, the claim may never be resolved as it can become lost or forgotten.

Many modifications and other embodiments of the inventions set forth herein will come to mind to one skilled in the art to which these inventions pertain having the benefit of the teachings presented in the foregoing descriptions and the associated attachments. Therefore, it is to be understood that the inventions are not to be limited to the specific embodiments disclosed and that modifications and other embodiments are intended to be included within the scope of the present disclosure. Although specific terms are employed herein, they are used in a generic and descriptive sense only and not for purposes of limitation.

1. A method for web-based claim processing, comprising:
identifying at least one audit claim;
electronically associating the at least one audit claim to one or more documents associated with the at least one audit claim; and
making the at least one audit claim and the one or more associated documents available for review electronically.

2. The method of claim 1, further comprising providing secure access the at least one audit claim and the one or more associated documents via an Internet browser.

3. The method of claim 2, further comprising delivering notice to a claimant of the accessibility of at least one audit claim and the one or more associated documents.

4. The method of claim 2, further comprising receiving from a claimant one or more of approval, comment and modification relating to the at least one audit claim.

5. The method of claim 2, further comprising delivering notice to a vendor of the accessibility of at least one audit claim and the one or more associated.

6. The method of claim 2, further comprising receiving from a vendor one or more of approval, comment and modification relating to the at least one audit claim.

7. The method of claim 2, further comprising receiving from a vendor a document relating to the at least one audit claim.

8. A method for web-based claim processing, comprising:
obtaining electronic versions of documents relating to an audit;
identifying at least one audit claim based at least in part on the documents;
generating an electronic record of the at least one audit claim;
electronically associating the electronic record for the at least one audit claim to one or more of the documents; and
making the at least one audit claim and the one or more associated documents available for review remotely over a network.

9. The method of claim 8, further comprising providing secure access the at least one audit claim and the one or more associated documents via an Internet browser.

10. The method of claim 8, further comprising delivering notice to a claimant of the accessibility of at least one audit claim and the one or more associated documents.

11. The method of claim 8, further comprising receiving from a claimant one or more of approval, comment and modification relating to the at least one audit claim.

12. The method of claim 8, further comprising delivering notice to a vendor of the accessibility of at least one audit claim and the one or more associated.

13. The method of claim 8, further comprising receiving from a vendor one or more of approval, comment and modification relating to the at least one audit claim.

14. The method of claim 8, further comprising receiving from a vendor a document relating to the at least one audit claim.

15. A computer-based system for web-based claim processing in an audit, comprising:
a database of electronic documents associated with the audit;
a claim manager that receives and processes an audit claim associated with one or more of the electronic documents;
an e-mail server that generates a message notifying the accessibility of the audit claim and one or more of the documents via an Internet browser; and
wherein the claim manager generates web pages presenting the audit claim and associated documents for review and processes inputs received through the webpage interfaces.

16. The system of claim 15, wherein the e-mail server sends the message to a claimant.

17. The system of claim 15, wherein the e-mail server sends the message to a vendor.

18. The system of claim 15, wherein the web server is configured to receive at least one of approval, comment, document and modification associated with the audit from one of a claimant and vendor.

19. The system of claim 18, wherein a confidentiality level is associated with the one of approval, comment, document and modification.

20. The system of claim 18, further comprising a viewer associated with the claim manager for presenting the associated documents to remote viewers.
